(19) United States
(12) Patent Application Publication
(10) Pub. No.: US 2025/0130805 A1
(43) Pub. Date: Apr. 24, 2025

(54) NON-VOLATILE MEMORY BASED NEAR-MEMORY COMPUTING MACHINE LEARNING ACCELERATOR

(71) Applicant: SEMIBRAIN INC., Seongnam-si (KR)

(72) Inventor: Daewung Kim, Seoul (KR)

(21) Appl. No.: 18/918,013

(22) Filed: Oct. 16, 2024

Related U.S. Application Data
(60) Provisional application No. 63/544,693, filed on Oct. 18, 2023.

(51) Int. Cl. G06F 9/30; G06F 7/53; G06F 7/544; G06F 13/16

(52) U.S. Cl. CPC G06F 9/30145; G06F 7/53; G06F 7/5443; G06F 9/30038; G06F 13/1673

(57) ABSTRACT

A computing device comprising: an input circuit to receive and buffer intermediate inputs being processed by the computing device and inputs transferred between a host device and the computing device; an input decoder to fetch inputs from the input circuit and arrange corresponding input data with n elements into a specific memory address; a weight decoder, coupled to the non-volatile memory device with a plurality of high bandwidth data bus, to fetch weights from the non-volatile memory and arrange corresponding weight data with n elements into a specific memory address; a product engine circuit with a group of dot product engines for taking the input data and the weight data, and returning weighted sum; a 10 quantization logic to quantize the weighted sum into a set of discrete values; and a control logic circuit to selectively enable or disable data elements of each data input data a specific number of times.

### CROSS-REFERENCE TO RELATED APPLICATIONS

This application claims priority to and the benefit of Provisional U.S. Patent Application No. 63/544, 693 filed on Oct. 18, 2023.

### TECHNICAL FIELD OF THE INVENTION

The subject matter disclosed herein generally relates to the field of computing systems and, more particularly, to a hardware accelerator for machine learning computing systems.

### BACKGROUND OF THE INVENTION

Machine learning applications are increasingly used in artificial intelligence algorithms, such as audio/video recognition and video summarization. A variety of hardware platforms are currently being used to run these workloads, including a CPU and DRAM, a set of non-volatile memories, and a memory controller connecting the CPU and non-volatile memories.

Conventional computing systems required to transmit weight data stored in non-volatile memory and intermediate data multiple times from memory to computing circuit.

This involves a lot of performance degradation, both power and time, especially when running large AI models such as a large language model (LLM), which requires vast amounts of parameters that cannot fit into system memory.

Machine learning uses artificial networks and learns from vast amounts of text data, identifying patterns and relationships within the data. Typically, the size of the data for machine learning is more significant than the readily available DRAM capacity embodied in conventional computing systems. So, it would be expensive and consume a lot of power when all the data is stored in DRAM for refresh operation. Alternatively, the data may be stored in non-volatile flash memory or other dense storage media because of the large storage capacity per given cost.

Although the data for machine learning can be stored in non-volatile flash memory, training and deploying for machine learning requires transferring a huge amount of data, which results in a bottleneck on a data bus in a conventional computing system. A flash-based Near-Memory Computing ML Accelerator has been proposed to enable power efficient computation compared to conventional computing systems.

### SUMMARY OF INVENTION

This invention discloses a hardware computing system and, more particularly, a improved hardware accelerator for machine learning computing systems. Various aspects provide method methods, devices, and non-volatile process-readable storage media for performing accelerating computing data process within a near memory computing unit (NMCU).

According to the present invention, a computing device coupled between a non-volatile memory device and a host device via database, said computing device comprising: an input circuit, coupled to the host device, configured to receive and buffer (i) intermediate input data that is being processed by the computing device and (ii) inputs transferred between the host device and computing device; an input decoder with one or more rows of buffers configured to fetch inputs from the input circuit and arrange corresponding input data (x) with n elements into a specific memory address to be accessed for reading or writing; a weight decoder, directly coupled to the non-volatile memory device with a plurality of high bandwidth data bus, configured to fetch weights from the non-volatile memory and arrange corresponding weight data (w) with n elements into a specific memory address to be accessed for reading or writing; a product engine circuit comprising a group of dot product engines for taking the input data (x) and the weight data (w), both with the n elements, and returning weighted sum (y); a quantization logic arranged between the product engine and the input circuit, configured to quantize the weighted sum (y) into a smaller set of discrete values with lower precision; and a control logic circuit configured to selectively enable or disable data elements of each data input data (x) a specific number of times in producing the weighted sum (y).

In some embodiments, the input circuit comprises an input buffer that temporarily stores data from the host device while the data is being moved from the host device to the input decoder.

In some embodiments, the input circuit further comprises a ping-pong buffer having two buffers of equal or different size, which alternately write back and output data for predefined cycles in a way that while the input decoder reads from a first buffer, the quantization logic circuit writes to a second buffer, and once the input decoder has finished reading from the first buffer, the first buffer is switched back to the write back buffer from the quantization logic circuit and the second buffer is switched to transfer the stored data to the input decoder.

In some embodiments, the input circuit further comprises a multiplexer having multiple input lines connected to both the input buffer and ping-pong buffer and a single outline connected to the input decoder, said output line carries selected input from either the input buffer or the ping-pong buffer.

In some embodiments, the input decoder is configured for decoding the data from the input circuit into a suitable format to be processed at the dot product engine circuit and for storing the input data.

In some embodiments, wherein the input decoder comprises a plurality of buffer cells for storing multiple elements of the input data (x), said buffer cells being organized in row and column locations.

In some embodiments, the weight decoder is configured with multiple memory blocks in parallel to retrieve different portions of the weights stored in the non-volatile memory device simultaneously.

In some embodiments, the control logic circuit is configured to repeat a process of allocating memory address for multiple elements of the input data (x) in a row-majoring order by placing an offset at a base address of each row buffer memory in the input decoder. In some embodiments, the control logic circuit is configured to repeat a process of allocating memory address for multiple elements of the input data (x) in column-majoring order by placing an offset at a base address of each row buffer memory in the input decoder.

In some embodiments, the control logic circuit is configured to allocate a memory address associated with the non-volatile memory bank that contains a group of weights such that the address space of the bank indicates the address space of the group of weights.

In some embodiments, the control logic circuit is configured to generate and transmit enabling signals to activate a plurality of dot product engines for producing dot products as directed.

In some embodiments, the control logic circuit is configured to generate and transmit mask control signals to the dot product engines to selectively activate or deactivate elements of the decoded input data x in producing the dot product.

In some embodiments, the control logic circuit is configured to determine an iteration number, which is how many times the decoded input data x and decoded weight data w are calculated for a long chain calculation.

In some embodiments, the control logic circuit is configured to transmit a number of elements signal specifying the number of the decoded input data and the decoded weight data elements for a single calculation in each DPE.

In some embodiments, the computing circuit further comprises an interconnect circuit to which all the input decoder, weight decoder, and control logic circuit are connected in parallel, and a plurality of dot product engines are connected in parallel to the interconnect circuit.

In some embodiments, the interconnect circuit is configured to direct individual data from the input decoder, weight decoder, and control logic circuit to inputs to each dot product engine in a synchronized manner.

In some embodiments, the dot product engines comprise (i) a plurality of data selectors arranged in parallel for selectively inputting individual elements of the decoded input data x according to the mask control signals received from the control logic circuit, (ii) a plurality of multipliers arranged in parallel to simultaneously multiply the selected elements of the decoded input data x and corresponding multiple elements of decoded weight data w, and (iii) an accumulator for storing multiple additions of output data from the plurality of multipliers.

In some embodiments, the quantization logic is connected to a bias buffer, which is arranged between the data bus and the quantization logic, stores a constant value to be added to an intermediate output from the quantization logic for offsetting the intermediate output in a specific direction.

In some embodiments, the quantization logic circuit is connected to a scale buffer, which is arranged between the data bus and the quantization logic, stores a constant scale value to be multiplied to a sum of the intermediate output and the bias value for bringing the summed output within a specific range.

An aspect method may apply to a computing device coupled between a non-volatile memory device and a host device, said method repeats a step comprising: obtaining and storing inputs from the host device or the computing device; converting weights from the non-volatile memory into a suitable format to output corresponding dot products; summing the dot products and quantizing the summed dot product (y) into a value (q) with a targeted format; and updating inputs with the quantized value (q).

### BRIEF DESCRIPTION OF THE DRAWINGS

FIGS. 1A and 1B show a simplified block diagram of a conventional computing system and a proposed computing system for a machine learning operation.

FIG. 2 is a block diagram illustrating overall structure of Near Memory Computing Unit (NMCU) according to one embodiment of the present invention.

FIG. 3 is a component block diagram illustrating exemplary operational steps of the near memory computing device (e.g., Input Unit) of FIG. 2.

FIG. 4 is a component block diagram illustrating a structure of an example dot product engine (DPE) of FIG. 2.

FIGS. 5A is a component block diagram of an input unit and an input decoder in the near computing unit of FIG. 2.

FIG. 5B is data structure diagram illustrating data tables including offset values based on various operation mode according to some embodiments of the present invention.

FIG. 6 is a block diagram of a weight decoder in the near memory computing unit of FIG. 2.

FIG. 7 is data structure diagram illustrating a data table including offset values for use in various aspects.

FIG. 8 is a component block diagram illustrating quantization logic circuit with a scale buffer and a bias buffer according to one embodiment of the present invention.

FIG. 9 is a data structure diagram illustrating a data table including quantized values by bit-shift operation according to some embodiments of the present invention.

FIG. 10 is a component block diagram an exemplary control logic circuit in the near computing unit of FIG. 2.

FIG. 11 is a diagram illustrating an exemplary single calculation process in each dot product engine in the near computing unit of FIG. 2 in some embodiments of the present invention.

FIG. 12 shows an exemplary timing chart of n iterations of DPE calculation in some embodiments of the present invention.

### DETAILED DESCRIPTION OF THE INVENTION

In the following detailed description of the invention, reference is made to the accompanying drawings that form a part hereof, which is shown by way of illustration and specific embodiment. In the drawings, like numerals, features of the present invention will become apparent to those skilled in the art from the following description of the drawings. Understanding that the drawings depict only typical embodiments of the invention and are not, therefore, to be considered limiting in scope, the invention will be described with additional specificity and detail through the accompanying drawings.

Terms containing ordinal numbers, such as first, second, etc., may describe various components, but the terms do not limit the components. The above terms are used only to distinguish one component from another.

When a component is said to be “connected” or “accessed” to another component, it may be directly connected to or accessed to the other component, but it should be understood that other components may exist in between. On the other hand, when it is mentioned that a component is “directly connected” or “directly accessed” to another component, it should be understood that there are no other components in between. Singular expressions include plural expressions unless the context clearly dictates otherwise.

In this application, it should be understood that terms such as “comprise” or “have” are meant to indicate the presence of features, numbers, steps, operations, components, parts, or combinations thereof described in the specification; however, these terms do not exclude the possibility of the additional features, numbers, steps, operations, components, parts, or combinations thereof existing or being added in advance. Also, the term “unit” is used herein to mean a self-contained component, a component circuit, or module that performs a specific function within a larger computer system.

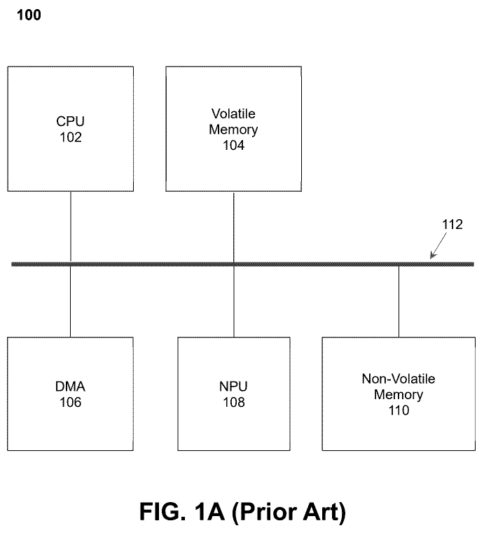

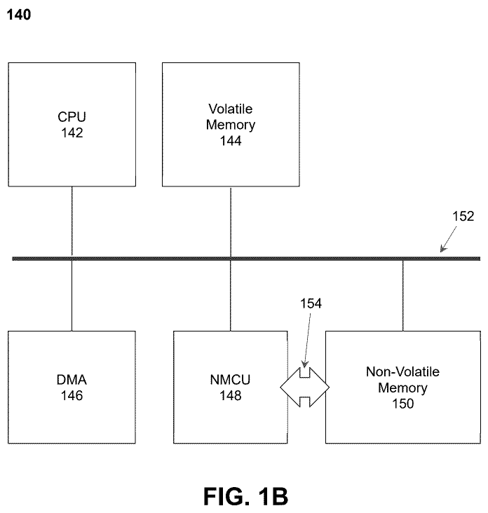

FIG. 1A shows a simplified block diagram of a conventional computing system 100 for a machine learning operation. Referring to FIG. 1A, the conventional computing system 100 comprises a CPU 102, a neural processing unit NPU 108, a volatile memory 104, a non-volatile memory 110, a direct memory access DMA 106, and a data bus 112.

The CPU 102 controls a whole computing system 100 and communicates with other circuits, the volatile memory 104, the NPU 108, the non-volatile memory 110, and the DMA 106 via a data bus 112. The data bus 112 allows units of the computing system to work together and exchange data with each other. The CPU 102 may use the volatile memory 104 to store data, program instructions, or other information and control the whole computing system 100, while the NPU 108 computes the calculation of the machine learning operation for better performance. The CPU 102 can be a type of processor, such as an application processor (AP), a microcontroller unit (MCU), or a graphic processing unit (GPU).

The neural processing unit (NPU) 108 is a kind of processor in the computing system 100 that helps the CPU 102 and computes the calculation of the machine learning operation. It works alongside the CPU 102, offloading certain operations to speed up processing and enhance performance. The NPU 108 performs the specialized task, namely, neutral network operations, more efficiently than the CPU 102 only, which can speed up the computer overall. By handling specialized tasks, the NPU 108 allows the CPU 102 to focus on other operations, improving efficiency.

The volatile memory 104 is a common random access memory (RAM) used in PCs, workstations, and servers. It allows the CPU 102 and the NPU 108 to access any part of the memory directly rather than sequentially from a starting place. The volatile memory (104) can be DRAM or SRAM.

The non-volatile memory 110 is a type of solid-state storage used to implement neural network computing. It can retain data even when the power is off and can be electrically erased and reprogrammed.

The DMA 106 is a control unit for the memory access. It allows other units of the computing system 100 to access the volatile memory 104 independently of the CPU 102. Thus, the DMA 106 allows the CPU 102 to focus on other operations, improving efficiency.

The conventional computing system 100 can process machine learning operations provided it does not store large amounts of data in the non-volatile memory (110). Obtaining data stored in the non-volatile memory 110 can be prolonged, with a considerable amount of data needed for machine learning, as explained in the background. The operation of machine learning can slow down the current computing system 100 due to data transfer limitations. As a result, existing computing systems have trouble running Machine Learning (ML) with large capacities due to the bottleneck of the data bus 112. As such, it is necessary to design and develop an optimized computing system to train and run ML efficiently.

FIG. 1B shows a simplified block diagram of an example computing system of the present invention for a machine learning operation. In FIG. 1B, the computing system 140 includes a near memory computing unit (NMCU) 148 configured to process huge datasets of machine learning (ML) operation.

The computing system 140 comprises a CPU 142, a volatile memory 144, direct memory access (DMA) 146, a NMCU 148, a non-volatile memory 150, and a data bus 152. The CPU 142, volatile memory 144, and DMA 146 are substantially the same as those in the computing system 100, as depicted in FIG. 1A. Also, the computing system 140 in FIG. 1B may include a Hard Disk Drive (HDD), a Solid State Drive (SSD), or a type of non-storage, as well as transitory storage, such as Cache Memory, and network buffers.

All the computing units of the proposed computing system 140 are connected via the data bus 152. The NMCU 148 computes the calculation of ML operation without intervention of the CPU 142 and improves performance without a bottleneck on the data bus 152 by fetching the weight data on the fly from non-volatile memory 150 and utilizing a built-in ping-pong buffer (not shown) using a directly coupled high bandwidth communication channel 154. The NMCU 148 can minimize the usage of the data bus 152 by storing the intermediate calculation results of a long chain of the calculation of ML operation in the ping-pong buffer and contacting the volatile memory 144 only for data of initial input, scale, and bias, and storing of the final result of the calculation through the control of DMA 146 without intervention of the CPU 142.

The non-volatile memory 150 has the same structure and function as FIG. 1A so that it can store huge data of weight parameters persistently during the power-off. However, using the high bandwidth communication channel 154 between the NMCU and the non-volatile memory 150 can directly transmit huge amounts of weight parameters data without passing through the volatile memory 144. With the directly coupled communication channel 154, the data path can be simplified by reducing long storage latency and data movement, exhausting the volatile memory 144 footprint. The exemplary non-volatile memory is embedded Flash memory, NAND flash, NOR flash, ReRAM, MRAM, PCM, FcFET, etc.

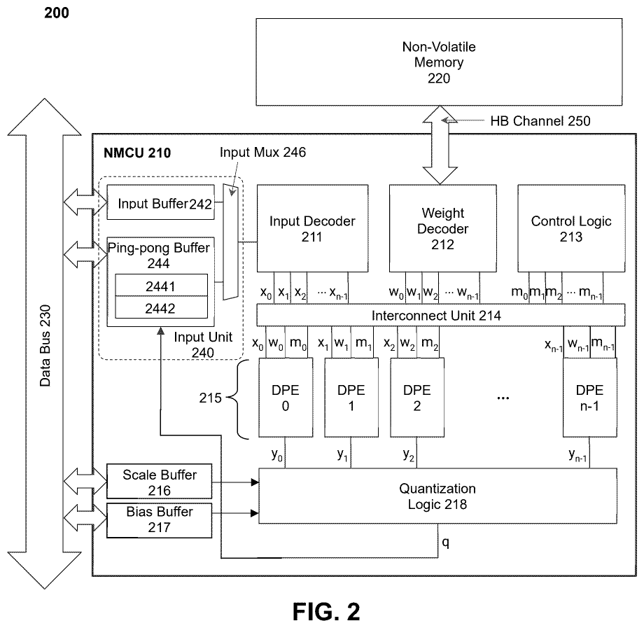

FIG. 2 shows an overall structure 200 of a Near Memory Computing Unit (NMCU) 210, non-volatile memory 220, and a data bus 230 according to some embodiments of the present invention. Referring to FIG. 2, the NMCU 210 is directly connected to the data bus 230 and the non-volatile memory 220. The NMCU 210 comprises an input unit 240, an input decoder 211, a weight decoder 212, a control logic 213, an interconnect unit 214, a plurality of dot product engine (DPE) 215, a scale buffer 216, a bias buffer 217, and a quantization logic 218.

The input unit 240 comprises an input buffer 242, a ping-pong buffer 244, and an input mux 246. The input buffer 242 receives an initial input from the volatile memory 144 directly through the data bus 230 under the control of the DMA 146 and sends the initial input to the input mux 246.

The ping-pong buffer 244 includes two identical buffers 2441, 2442 to write back the intermediate results of the previous calculation of a long chain calculation and send the intermediate calculation result to the input mux 246.

In this case, the previous calculation is calculated outputs transmitted from Quantization Logic 218. One buffer 2441, 2442 is being written to while the other buffer 2441,2442 is being read from. Once writing to the first buffer is complete, the roles switch and the second buffer becomes the write buffer while the first is read from. This continues in a cyclical fashion, resembling the back-and-forth motion of a ping-pong ball.

The input mux 246 is a digital circuit that selects one of several input signals and forwards the selected input to a single output line. In this case, the input mux 246 sends either the initial input received from the input buffer 242 or the intermediate calculation result received from the ping-pong buffer 244 to the input decoder 211.

The input decoder 211 is a circuit that converts an input code into a set of output signals. In this case, the input decoder 211 decodes the data received from the input mux 246 into n numbers of data set, from x₀ to xₙ₋₁, and transmits the data set, x₀˜xₙ₋₁, to the interconnect unit 214. Each of the input data, xₙ, consists of a plurality of elements, from xₙ₀ to Xₙₘ.

The weight decoder 212 is a circuit configured to directly receive the data of weight parameters from the non-volatile memory 220 through the high bandwidth communication channel 250. The weight decoder 212 decodes the received weight data into n numbers of a weight data set and transmits the decoded weight data set, w₀˜wₙ₋₁, to the interconnect unit 214. Just like the input data, each of the weight data, wₙ, consists of a plurality of elements, from wₙ₀ to wₙₘ.

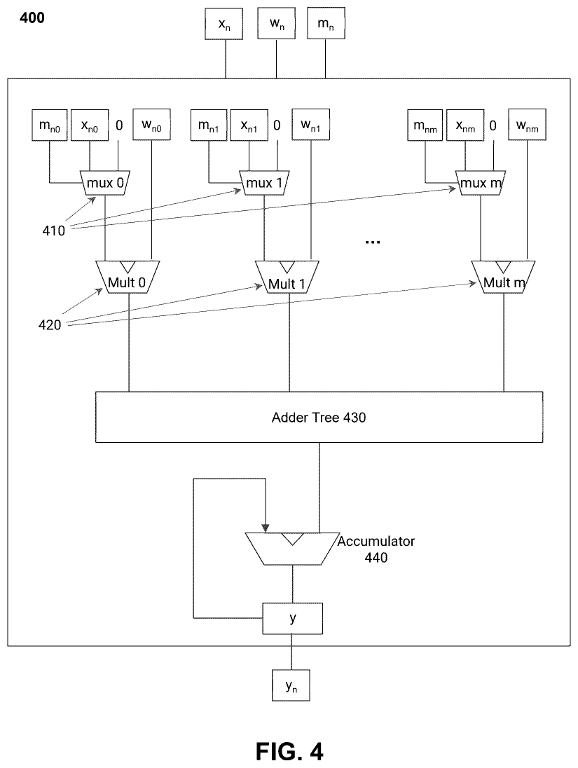

The control logic 213 sends n numbers of mask control signals, m₀˜mₙ₋₁, to the interconnect unit 214. The mask control signals dictate which parts of the input data are “visible” or “active” and which are ignored or suppressed in connection with a set of dot product engine DPE 215. As shown in FIG. 4, each element in the mask control signal corresponds to an element in the input data. The values within the mask control signal determine how the corresponding input data elements are treated. Also, each of the control signals, mₙ, consists of a plurality of elements, from mₙ₀ to mₙₘ.

The interconnect unit 214 receives the decoded input data set, x₀˜xₙ₋₁, from the input decoder 211, the decoded weight data set, w₀˜wₙ₋₁, from the weight decoder 212, and the mask control signals, m₀˜mₙ₋₁, from the control logic 213. Then the interconnect unit 214 transmits each data and control signal to the corresponding numbered DPE 215. For example, x₀, w₀, and m₀ are transmitted to DPE 0, x₁, w₁, and m are transmitted to DPE 1, and xₙ₋₁, wₙ₋₁, and mₙ₋₁ are transmitted to DPE n−1.

The NMCU 210 includes a plurality of the dot product engine (DPE) 215. Each DPE receives one input data xₙ, one weight data wₙ, and one mask control signal mₙ from the interconnect unit 214. Each DPE multiplies input data x, and weight data wₙ according to the received each mask control signal mₙ. Outputs of DPEs, named y₀˜yₙ₋₁, are transmitted to the quantization logic 218. More details about the DPE will be explained in FIG. 4.

The scale buffer 216 and the bias buffer 217 receive scale data and bias data from the volatile memory 144 directly through the data bus 230 under the control of the DMA (146) and send those data to the quantization logic 218.

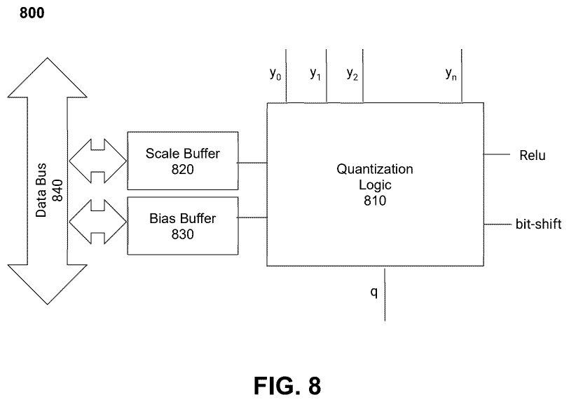

The quantization logic 218 receives outputs of DPEs, y₀˜yₙ₋₁, from a plurality of the DPE 215, scale data and bias data from the scale buffer 216 and the bias buffer 217 respectively. Based on the received data, the quantization logic 218 performs a quantization calculation and transmits the result of the calculation, q, to the ping-pong buffer 244. In this context, the quantization may involve simply rounding the floating-point weights and activations to lower precision. More details about the quantization logic will be explained in FIG. 8.

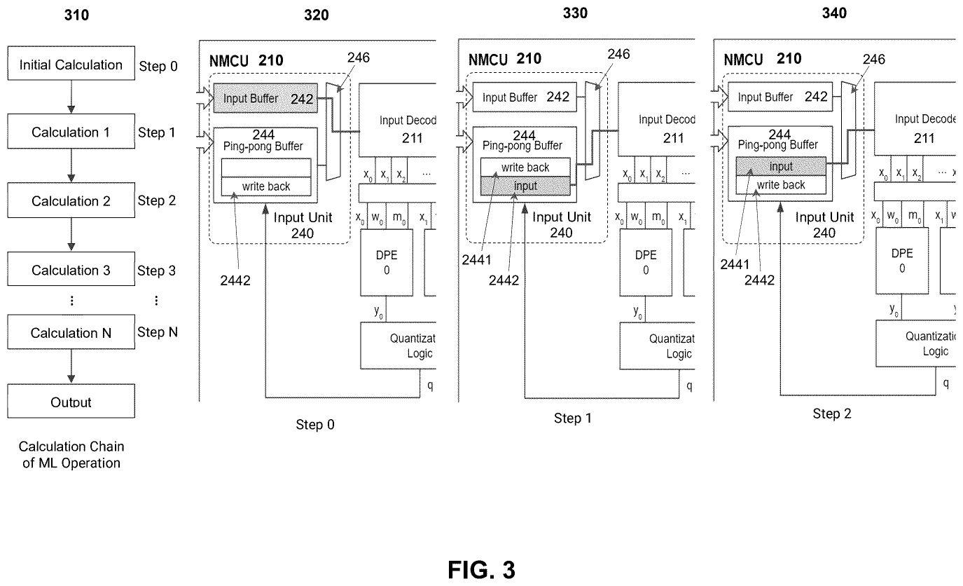

FIG. 3 shows an operation of the input unit 240 with ping-pong buffer according to one embodiment of the present invention. This long chain calculation is an exemplary automated process for making predictions based on an ML trained model configured with an ML accelerator. Flow chart 310 shows multiple repetitive operations (long chain calculations) according to one embodiment of the present invention.

These repetitive operations involve NMCU's operations comprising: (1) obtaining and storing elements of an input data (x) from the volatile Memory 144 or the NMCU 148; (2) converting elements of a weight data (w) from the non-volatile memory 150 into suitable formats; (3) outputting corresponding elements of a dot product (y); summing the dot product elements into a single dot product (y) and quantizing the summed dot product (y) into a value (q) with a targeted format; and updating input data X with the quantized value (q). Also, how the two buffers 2441, 2442 in NMCU 210 are sequentially working in an alternating fashion is illustrated in block diagrams 320, 330, and 340,

At Step 0, the input buffer 242 (in gray) temporarily stores data x from the nonvolatile memory 110 and filters it through the input mux 246 for transmission to the input decoder 211. On the basis of the transformed input data X (x0, x1, x2, . . . , and so on) data and the weight data W (w0, w1, w2, . . . , and so on) transformed by the weight decoder 212, a group of dot product engines (DPEs) perform dot products (y0, y1, y2 . . . , and so on) simultaneously.

These dot products are summed into a single dot product (y) and quantized into a value (q) in a targeted format. The quantized value (q) is then transmitted to the second ping-pong buffer 2442 in order to be used for input data x for sequential calculation, which is Calculation 1.

At Step 1, the second ping-pong buffer 2442 (in gray) transmits the firstly updated input data x to the input decoder 211 through the input mux 246. On the basis of the firstly updated input data X (x0, x1, x2, . . . , and so on) and the weight data W (w0, w1, w2, . . . , and so on) from the weight decoder 212, a group of parallel dot product engines (DPEs) produce dot products (y0, y1, y2 . . . , and so on) simultaneously. These dot products are summed into a single dot product (y) and quantized into a value (q) in a targeted format. The quantized value (q) is then transmitted to the first ping-pong buffer 2441 to be used for next input data x for sequential calculation, which is Calculation 2.

At Step 2, the NMCU 210 computes Calculation 2 of the long chain calculation, and transmits the data stored in a first buffer 2441, which is the result of Calculation 1 to the input decoder 211 via the input mux 246. On the basis of the secondly updated input data X (x0, x1, x2, . . . , and so on) and the weight data W (w0, w1, w2, . . . , and so on) from the weight decoder 212, a group of parallel dot product engines (DPEs) produce dot products (y0, y1, y2 . . . , and so on) simultaneously. These dot products are summed into a single dot product (y) and quantized into a value (q) in a targeted format. The quantized value (q) is then transmitted to the second ping-pong buffer 2442 to be used for next input data x for sequential calculation, which is Calculation 3.

Similarly to the calculations 1 and 2, for the pending Calculation 3 through Calculation N, the first buffer 2441 and the second buffer 2442 alternatively write back and outputs X data for predefined cycles in a way that while the input decoder reads from a first buffer, the quantization logic circuit writes to a second buffer, and once the input decoder has finished reading from the first buffer, the first buffer is switched back to the write back buffer from the quantization logic circuit and the second buffer is switched to transfer the stored data to the input decoder.

FIG. 4 shows the structure of a dot product engine (DPE) in one embodiment of the present invention. The dot product engines herein are similar to the dot product engine 215 in FIG. 2. The DPE 400 comprises a plurality of multiplier 420 and mux 410, an Adder Tree 430, and an accumulator 440 according to one embodiment of the present invention.

In terms of operations, the DPE 400 receives input data xₙ and weight data wₙ from the interconnect unit 214. A mask control signal mₙ is received from the control logic 213. Input data xₙ, weight data wₙ and mask control signal mₙ consist of a plurality of element, from xₙ₀ to xₙ₁, from wₙ₀ to wₙ₁, and from mₙ₀ to mₙ₁, respectively.

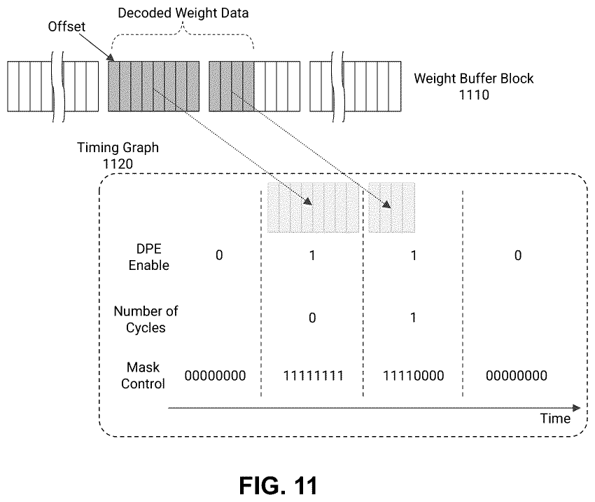

In this case, the DPE 400 includes a plurality of multipliers 420, from Mult 0 to Mult m, and m can be greater than or less than 1, which is the number of elements of the input data, xₙ, weight data wₙ, and mask control signal mₙ. If the number of multipliers 420, m, is greater than or equal to the number of elements, l, the m multipliers 420 can calculate all the elements of the input data and weight data in parallel at the same time. However, if the number of multipliers 420, m, is less than the number of elements, l, multiple calculations are required, and each result of the calculation is accumulated for a single computation. The multiple calculation process in each DPE for a single computation will be explained in FIG. 11. Each multiplier receives one input element of xₙ, one weight element of wₙ, and one mask control element of mₙ.

For example, the multiplier Mult m receives xₙₘ, wₙₘ, and mₙₘ. Each mux 410, connected to the corresponding multiplier 420, decides whether the weight element wₙₘ will be multiplied by the input element xₙₘ or by 0, based on the mask control element mₙₘ. Each multiplier 420 transmits a result of the multiplication to the Adder Tree 430.

The Adder Tree 430 adds received results of a plurality of multipliers 420 and transmits an addition result to the accumulator 440.

The Adder Tree 430 includes a plurality of adders (not shown) with a tree structure to add results of a plurality of multipliers 420.

The accumulator 440 accumulates the results of the Adder Tree 430 iteratively to complete the addition operation of the multiplication results. For example, if the DPE 400 includes 16 multipliers 420 and each input of the DPE 400, xₙ, wₙ, and mₙ, has 48 elements, 3 iterations of the accumulator are required for the complete addition of the multiplication results, xₙ*wₙ. Additionally, the accumulated result of the accumulator (440) is the overall result, yₙ, of the DPE 400.

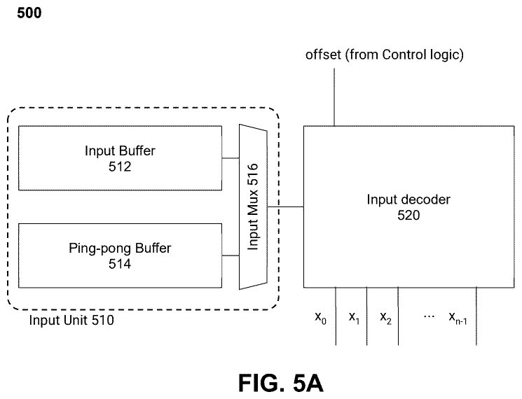

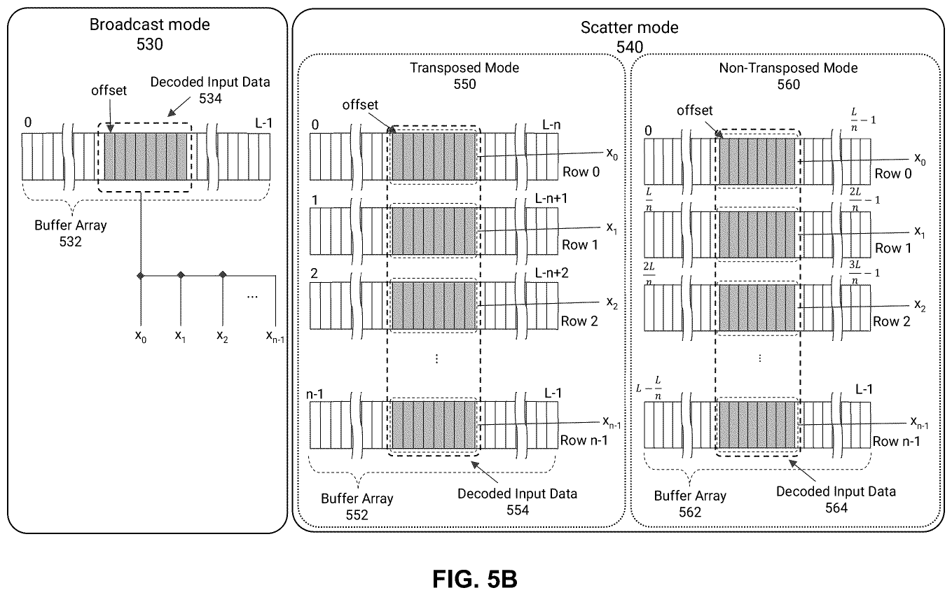

FIG. 5A shows a block diagram of the input unit and the input decoder described in FIG. 2 according to one embodiment of the present invention.

Input Unit 510 comprises an input buffer 512, a ping-pong buffer 514, and an input mux 516. A multiplexer 516 is configured with multiple input lines connected to both the input buffer 512 and ping-pong buffer 514 and a single output line connected to the input decoder 520. Also, the single output line carries selected input from either the input buffer 512 or the ping-pong buffer 514.

The input decoder 520 then decodes the data from the input mux 516 into a data set of n numbers, from x₀ to xₙ₋₁, to transmit these data sets to the same number of n DPEs 215 through the interconnect unit 214.

Also, the input decoder 520 receives offset information from the control logic 213 to select the input data for decoding. The offset information is a numerical value that specifies the relative position of a piece of data within a buffer memory structure. In addition, the control logic is configured to repeat a process of allocating memory address corresponding to a single transformed input data by adding one offset to a base address of buffer memory within the input decoder. A detailed explanation of allocating memory address to decoded input data x within the buffer memory is provided in FIG. 5B.

FIG. 5B shows a buffer array inside the input decoder 520 designed for broadcast mode 530 and scatter mode 540.

The left side figure of FIG. 5B shows the buffer array 532 and the decoded input data 534 for Broadcast mode 530. A buffer array is utilized as a buffer of input decoder for Broadcast mode 530. Buffer array 532 includes L buffers from buffer 0 to buffer L−1, and each buffer stores one element of input data. N denotes the dot product engine (DPE) coupled to the buffer array 532.

In Broadcast mode 530, the set of decoded input data 534 with l elements is sent to all DPEs 215 through the interconnect unit 214. Based on the offset value and the number of elements, the input decoder 520 decodes the input data set from the offset position of the buffer array 532.

For instance, given that (i) the offset is 32, (ii) the NMCU 210 contains a total of 16 numbers of DPEs 215, and (iii) the input data consists of eight elements, the input decoder 520 decodes the data elements stored in buffers 32 to 39 and transmits to the 16 DPEs 215 via the interconnect unit 214. The data from x₀ to x₁₅ have the same data elements from buffers 32 to 39, and the 16 DPEs 215 receive the same input data as shown in FIG. 5B. This broadcast mode is operated to apply the same input data for all DPEs connected to the Input Decoder, which are multiplied by multiple weights from Weight Decoder, as shown in FIG. 2. That is, when the input data from the weight decoder has l elements, the other data from Input decoder also has l elements.

In Scatter mode 540, different input data is transmitted to each DPE 215, as shown in the center and right sides of FIG. 5B. The Scatter mode has two types of decoding schemes: a transposed scheme 550 and a non-transposed scheme 560.

Like in broadcast mode, the input decoder 520 receives offset information from the control logic 213. The input mux 516 selects either the input buffer 512 or the ping-pong buffer 514 to receive the input data.

Buffer Array 552, 562 inside the input decoder 520 stores input data with L elements, from buffer 0 to buffer L−1, and is divided into buffer rows equal to the number of DPEs. For example, an array of buffer rows from row 0 to row n−1 may be included within the Buffer Array 552,562 in response to n numbers of DPEs.

Transposed Mode 550 The starting buffer of each buffer row of n buffer rows can become buffer 0, buffer 1, buffer 2, . . . , and buffer n−1, which store element 0, element 1, element 2, . . . , and element n−1, respectively. Each of the n buffer rows transmits the decoded input data 554 to the corresponding DPE of n DPEs 215, starting from the buffer that is offset from a beginning buffer in each row. This input data X with l elements becomes the decoded input data 554 as feeding input data into DPEs.

For example, in the case when (i) the offset value is 32, (ii) the NMCU (210) includes a total number of sixteen DPEs 215, and (iii) the decoded input data 554 includes eight elements, then the buffer consists of 16 rows from row 0 to row 15. The row 0 transmits eight elements-buffer 512, 528, 544, . . . , 624-to DPE 0. The row 1 transmits eight elements-buffer 513, 529, 545, . . . , 625-to DPE 1, the row 2 transmits eight elements-buffer 514, 530, 546, . . . , 626-to DPE 2, and so on.

### Non-Transposed Mode 560

A buffer array 562 can include L numbers of buffers and n numbers of buffer rows ranging from row 0 to row n−1.

Each buffer row of n buffer rows transmits the decoded input data 564 decoded by the input decoder 520 to the corresponding DPE of n DPEs 215. Each buffer row

$$\frac{L}{n}$$

buffers and the buffer array 562 stores the received input data sequentially. Thus, from element 0 to element

$$\frac{L}{n} - 1$$

of the received input data are stored in row 0 of the buffer array 562, and from element

$$\frac{L}{n}$$

to element

$$\frac{2 L}{n} - 1$$

of the received input data are stored in row 1 of the buffer array 562, and so on.

Each buffer row transmits the decoded input data 564 decoded by the input decoder 520 to a corresponding DPE 215 through the interconnect unit 214, and starting from the buffer that is offset from the starting buffer of each row, the number of elements, l, becomes the decoded input data 564 for that DPE. For example, if the offset is 32, the NMCU 210 includes 16 DPEs 215, and the decoded input data 564 includes 8 elements, then the buffer consists of 16 rows from row 0 to row 15. The row 0 transmits 8 elements—from buffer 32 to 39—to DPE 0, the row 1 transmits 8 elements—from buffer

$$\frac{L}{16} + 32 to \frac{L}{16} + 39 - to DPE 1 ,$$

and so on.

Note that the scatter mode 540 optionally re-orders the input or ping-pong buffer arrays as a transposed 550 shape as well as a non-transposed 560 shape. This feature enables it to support various ML operations like depth-wise convolution, which is commonly used in CNNs (Convolutional Neural Networks) in machine learning.

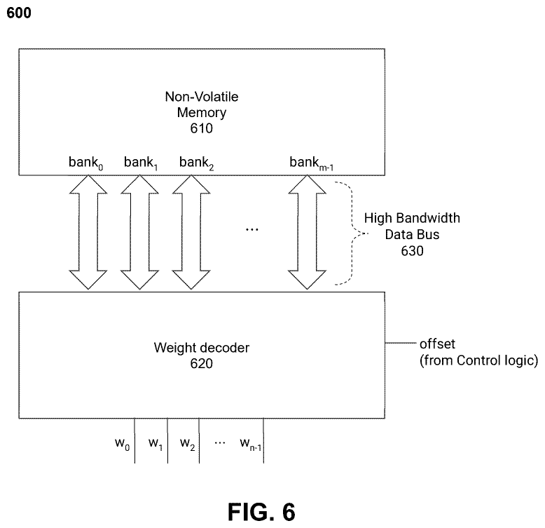

FIG. 6 shows a block diagram of a weight decoder coupled to non-volatile memory according to one embodiment of the present invention.

In the diagram 600, the weight decoder 620 is connected to the non-volatile memory 610 via a high bandwidth data bus 630.

The non-volatile memory 610 comprises a plurality of a bank (buffer) as a temporary data storage area during data transfer operations.

High Bandwidth Data Bus 630 refers to the data bus that can handle a large volume of data transfer between Non-Volatile Memory 610 and Weight Decoder 620 per unit of time. As shown herein, each bank transmits huge data of weight parameters through its own high bandwidth data bus 630 simultaneously to maximize throughput, the rate at which data is successfully transferred over a given period.

The non-volatile memory 610 transmits huge weight data of ML operation and is slower compared to the volatile memory 144. Therefore, even when using a high bandwidth data bus, utilizing a single data bus for data transfer can consume a significant amount of time, leading to reduced overall computing system efficiency. So, a plurality of banks within the non-volatile memory 610, each being connected to the corresponding high bandwidth data bus 630, can maximize the throughput of the overall computing system.

The weight decoder 620 includes the same number of buffer blocks (not shown) as the number of banks to store the weight data received from each bank of the non-volatile memory 610. The weight decoder 620 decodes the weight data received from the non-volatile memory 610 into n data sets, from w₀ to wₙ₋₁, equal to the number of DPEs 215, and transmits those data sets to the corresponding DPEs 215 through the interconnect unit 214. Also, the weight decoder 620 receives offset information from the control logic 213.

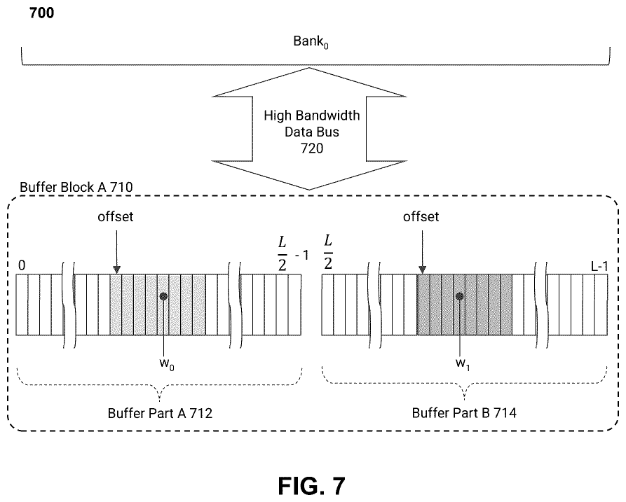

FIG. 7 shows a weight decoder buffer block according to one embodiment of the present invention. A plurality of Buffer Blocks 710 can be embodied into the weight decoder 620 to store weight data received from the corresponding bank, inside the non-volatile memory 610.

Bankₙ refers to a section or portion of non-volatile memory.

High Bandwidth Data Bus 720 refers to the data bus that can handle a large volume of data transfer between the NMCU 210 (weight decoder 212) and the Non-volatile Memory 220 per unit of time. In this case, when the system 200 uses multiple memory banks (Bankₙ) it can effectively split the data transfer load across multiple bus channels. Each bank has its own dedicated data bus lines, increasing the overall throughput and enabling parallel data access according to one embodiment of the present invention. The weight data received from each bank at a time is stored in the corresponding buffer block 710, and this buffer block 710 can be allocated to one or more DPEs 215 to maximize the throughput of the overall computing system.

Buffer Block A 710 is connected to bank 0 of the non-volatile memory 610 via a high-bandwidth data bus 720. Buffer Block A 710 includes L buffers, from buffer 0 to buffer L-1, which respectively store element 0 to element L−1 of the received weight data.

In one embodiment, Buffer Block A 710 is allocated to two DPEs, DPE 0 and DPE 1. The decoded weight data w₀ and w₁, stored in Buffer Block A 710, can be transmitted to the corresponding DPE 0 and DPE 1 through the interconnect unit 214.

Since the Buffer Block A 710 is allocated to two DPEs, it is divided into two buffer parts: Buffer Part A 712, and Buffer Part B 714.

Starting from the offset of each divided buffer part, l elements of decoded weight data are transmitted to the corresponding DPEs 215 through Interconnect Unit 214.

For example, if the offset is 32, the number of buffers in buffer block A 710, L, is 256, and the number of elements of each decoded weight data, l, is 8, then the buffer part a 712 consists of buffer 0 to 127 and the buffer part b 714 consists of buffer 128 to 255. The decoded weight data of the buffer part a 712, w₀, consists of 8 elements of the received weight data stored in buffers 31 to 38, and the decoded weight data of the buffer part b 714, w₁, consists of 8 elements of the received weight data stored in buffers 159 to 166.

FIG. 8 shows a block diagram of the quantization logic according to one embodiment of the present invention.

In FIG. 8, a quantization logic 810, as a functional circuit, is coupled to a scale buffer 820 and a bias buffer 830. In one embodiment, the quantization logic 810 can be configured to quantize the calculation results. In the context of the deep learning process, the quantization logic 810 is designed to significantly reduce the memory footprint and computational requirements of the deep learning model, making it more efficient for deployment on resource-constrained devices.

The quantization logic 810 includes the number of sub-calculation blocks (not shown) corresponding to the number of DPEs 215 to compute the equation below, using the dot product results received from the DPEs 215 and information from the scale buffer 820 and the bias buffer 830.

$${q}_{i}^{′} = {Scale}_{i} \times ( {y}_{i} + {Bias}_{i} ) \qquad Equation ( l )$$

The bit sizes of q′ᵢ, Scaleᵢ, yᵢ, and Biasᵢ in Equation (1) are all the same. The scale buffer 820 stores scale values applied to the above-noted processing for outputting q. The bias buffer 830 holds a constant bias value added to the above-noted processing for outputting q.

The scale buffer 820 and bias buffer 830 both receive the scale and bias values from the volatile memory 144 directly through the data bus 840 under the control of the DMA 146.

The scale buffer 820 and the bias buffer 830 transmit the scale data and bias data to each calculation block inside the quantization logic 810 for the corresponding calculation. In addition, the result of the calculation of Equation (1) can be quantized qi by the way in which, from multiple bit elements representing the calculated intermediate value, only the bit elements within the specific ranges predefined are selected. As a result of this, the output of the quantization logic 810, ‘q’ contains the same number of calculation results as the number of calculation blocks, from q₀ to qₙ₋₁. These calculation results are stored in the write back buffer inside the ping-pong buffer 244, shown in FIG. 3.

The bit-shift signal and ReLu signal are received from the CPU 142.

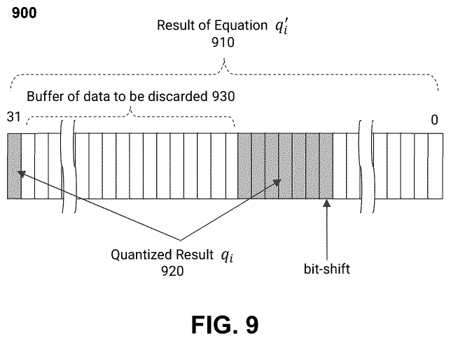

The ReLu (Rectified Linear Unit) signal is used to rectify the result of the DPE calculation. When the result of the DPE calculation is negative, the ReLU signal turns on if rectification is needed to make the DPE calculation result 0, and turns off if rectification is not needed. The bit-shift signal is used to quantize the results of the DPE calculation. The quantization process using the bit-shift signal will be explained in FIG. 9.

FIG. 9 shows an exemplary quantization process according to one embodiment of the present invention. This exemplary quantization is applied to the result 910 of Equation (1) inside a buffer of the Quantization Logic 810. Before quantization, the bit size of the result 910 of Equation (1), q′ᵢ, is k′, and after quantization, the bit size of the quantized result 920, qᵢ, is k. k′ and k can have any bit size, but k′ is always larger than k. Because quantization represents multiple numbers within a certain range as a single number, it reduces the number of representable values after quantization, which results in the use of a smaller bit size for representation. From an embodiment in FIG. 9, k′ is 32 and k is 8. A 32-bit q′ is bit-shifted based on the bit shift information 860 received from the CPU 142, with only 7 bits taken, and the MSB of q′ is used as the sign bit to generate an 8-bit qᵢ as shown in FIG. 9. Therefore, the final quantized output q 920 of the Quantization Logic 810 includes n 8-bit outputs, q₀ to qₙ₋₁, which are stored in the write back buffer of the ping-pong buffer 244.

An 8-bit binary number using the MSB as the sign bit can represent decimal values from −128 to 127. Therefore, negative numbers smaller than −128 are quantized to −128, and positive numbers larger than 127 are quantized to 127. For example, in the case of a negative number where the MSB is 1, if even a single bit of the data in the buffer of the 930 region in FIG. 9 is 0, it represents a negative number smaller than −128, and the quantized value becomes binary 10000000. In the case of a positive number where the MSB is 0, if even a single bit of the data in the buffer of the 930 region is 1, it represents a positive number larger than 127, and the quantized value becomes binary 01111111.

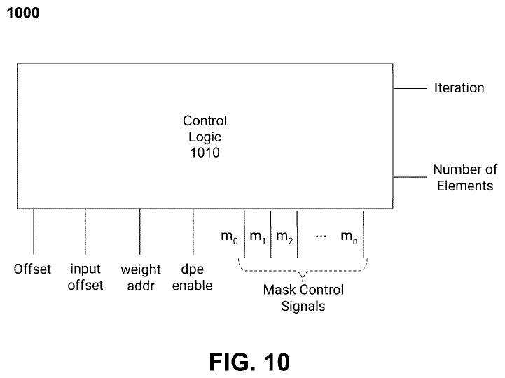

FIG. 10 shows a block diagram of a control logic circuit according to one embodiment of the present invention.

In a block diagram 1000, Control logic 1010, as a functional circuit, can be configured to control the whole computation process of the NMCU 210 according to one embodiment of the present invention.

Control Logic 1010 can generate and transmit an offset 1011 signal and an input offset 1012 signal to the weight decoder 620 and the input decoder 520 to specify the offset of the weight data and input data in the buffers of the weight decoder 620 and the input decoder 520, respectively.

The term “Input offset” 1011 can be a signal for assigning an offset address corresponding to the starting point of the decoded input data x to be stored in the buffers in the input decoder 520. Furthermore, the control logic 1010 can repeat a process of allocating a memory address corresponding to a single transformed input data by adding one offset to a base address of buffer memory within the input decoder.

Control Logic 1010 can also generate and transmit a weight address 1013 (signal) to instruct the weight decoder 620 to retrieve necessary weight data w from the non-volatile memory 110. The retrieved weight data w is then stored in the buffer in the weight decoder 620.

Control Logic 1010 can also generate and transmit a dpe enable signal 1014 to activate a plurality of DPEs 215 for performing calculations to produce dot products. In particular, the dpe enable signal 1014 activates the DPE 215 implementing the dot product operation in which input data x, w, and m are in the correct format and prepared for input.

Control Logic 1010 can also generate and transmit Mask Control Signals (m₀ to mₙ) corresponding to a number of DPEs 215. The signal could determine which element multiplications are actually calculated, as described in FIG. 4.

Control Logic 1010 can also control dpe enable 1014 signal and Mask Control signals 1015 to manage the calculation cycles in each DPE 215 for a single calculation. A more detailed explanation of the calculation cycles for a single calculation in each DPE 215 is provided in FIG. 11.

The term “Iteration” 1016 is used to mean a signal for carrying information of how many calculations should be performed during a long chain of calculations. The iteration signal 1016 can contain information about how many times the repeating process of NMCU 210 is repeated, each process comprising: (1) buffering received memory data into input and weight decoders, (2) converting the received data into a suitable format to output corresponding dot products, (3) summing the dot products and quantizing the summed dot product value Y into a targeted format, and (4) passing backward the adjusted dot product value to the Ping-pong buffer 244. As described in FIG. 3, machine learning operations frequently need to perform long-chain calculations.

The term “Number of Elements” 1017 is used to mean a signal for specifying the number of input data and weight data elements for a single calculation in each DPE 215.

FIG. 11 shows an embodiment of a single calculation process in each dot product engine. The buffer array at the top of FIG. 11 represents the weight buffer block 1110 inside the weight decoder 620.

In Timing graph 1120, the first row shows a bit information of DPE Enable signal. The second row displays the sequential number of the calculation cycles. The last row shows a bit information of Mask Control signals. DPE Enable signal and Mask Control signals are transmitted to the corresponding DPE 215 from the control logic 1010.

The weight data in the weight buffer block 1110 of the weight decoder 620 is selected based on the offset and the number of elements signals received from the control logic 1010 and is transmitted to the corresponding DPE 400 through the interconnect unit 214. The weight buffer block 1110 shows an embodiment of weight data decoding using the offset and the number of elements signals. Elements from the offset to the specified number of elements are selected for transmission to the corresponding DPE 400.

For example, the number of elements signal received from the control logic 1010 specifies the value as 12. Thus, 12 elements starting from the offset are selected for transmission, as shown by the shaded 12 elements with arrows in the timing graph 1120.

The first row of the timing graph 1120 shows the bit information of the DPE enable signal. The DPE enable bit becomes 1 only when DPE computation is required, otherwise, it remains 0. Thus, the DPE enable bit becomes 1 only when the selected 12 elements of the decoded weight data are transmitted.

The number of the calculation cycles are shown in the second row of the timing graph 1120. As explained in FIG. 4, each DPE 400 includes a plurality of multipliers 420, and each multiplier is capable of calculating one element of the input data and the weight data. If we assume that the number of the multipliers 420 in each DPE 400 is 8, as in the embodiment of FIG. 11, the transmitted weight data cannot be calculated in a single calculation because the DPE 400 can calculate up to 8 elements in parallel, but the transmitted weight data contains 12 elements. Therefore, the control logic 1010 transmits two bits of the DPE enable signal to the corresponding DPE 400 with a value of 1 to enable DPE 400 during 2 calculation cycles. The DPE 400 then performs 2 calculation cycles, cycle 0 and cycle 1, as shown in the second row of the timing graph 1120.

In the last row of the timing graph 1120, the bit information of the mask control signal is shown. The DPE receives the bit information of the mask control signal from the control logic 1010 through the interconnect unit 214. As explained above, the DPE 400 performs two calculation cycles because the number of elements, 12, is greater than the number of multipliers, 8. Therefore, all 8 elements in the first calculation cycle, cycle 0, are computed, but only 4 elements in the second cycle, cycle 1, need to be computed. The last row in the timing graph 1120 shows 8 bits of 1 for the first calculation cycle, and 4 bits of 1 and 4 bits of 0 for the second calculation cycle. As shown in FIG. 4, these mask control signals are transmitted from the control logic 1010 to the corresponding mux 410 of each DPE 400 through the interconnect unit 214, and each mux 410 determines whether the weight data element will be multiplied by the input data element or by 0, based on the received mask control signal.

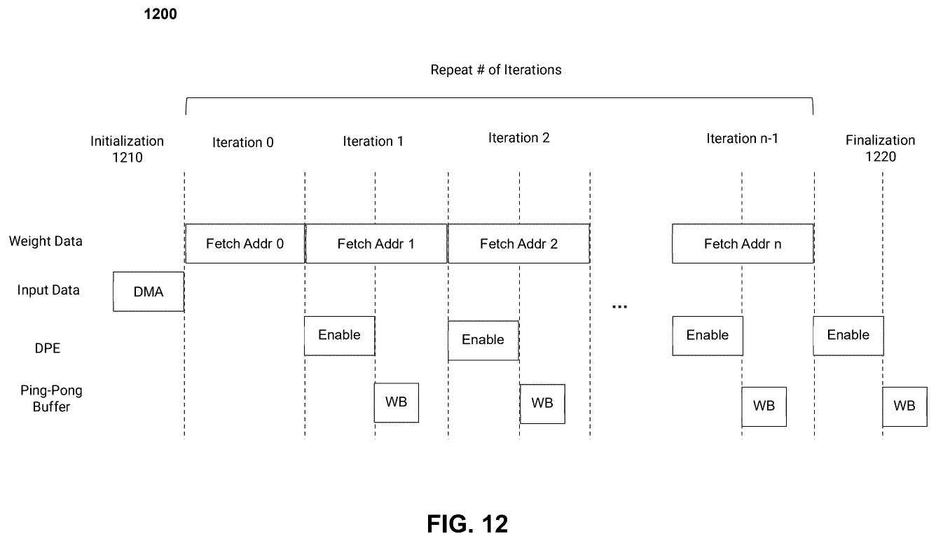

FIG. 12 shows a timing chart of n iterations of the near memory computing device in FIG. 2 for calculating a machine learning operation.

The effect of the iteration function is that a long chain of calculations can be performed by only one calculation command of the CPU 142. When the NMCU 210 calculation for the ML operation is performed without the iteration function, the CPU 142 must transmit a calculation command for every calculation of the long calculation chain. For the calculation of the ML operation, a long chain of calculations is performed very often, so the iteration function is very powerful.

In FIG. 12, each iteration stage is pipelined to maximize the performance of the ML operation. During the initialization stage 1210, the initial input data is transmitted from the volatile memory 144 through the data bus 152 under the control of the DMA 146. During the first iteration stage, iteration 0, the weight data for the first calculation is fetched from the non-volatile memory 220 through the high bandwidth data bus 250. In the first half of the second iteration stage, iteration 1, the first calculation of a long calculation chain is performed by the DPEs 215 and the quantization logic 218. In the second half of the second iteration stage, the result of the first calculation is stored in the write back buffer of the ping-pong buffer 244. Throughout the entire second iteration stage, the weight data for the second calculation is fetched from the non-volatile memory 220 through the high bandwidth data bus 250. Because the time required to fetch the weight data is relatively long compared to the calculation or result storage time, the pipelined iteration stage, where the calculation and write back occur during the fetching of weight data for the next calculation, can maximize the throughput of the ML computation. During each pipelined iteration stage, the same task as in the second iteration stage, iteration 1, is performed. In the n-th iteration stage, iteration n−1, the weight data for the last calculation of the long calculation chain is fetched while the n−1th calculation and result storage are performed. In the finalization stage 1220, the last calculation of the long calculation chain is performed, and the result of the calculation is stored.

What is claimed is:

1. A computing device coupled between a non-volatile memory device and a host device via database, said computing device comprising:
an input circuit, coupled to the host device, configured to receive and buffer (i) intermediate inputs that are being processed by the computing device and (ii) inputs transferred between the host device and the computing device;
an input decoder with one or more rows of buffers configured to fetch inputs from the input circuit and arrange corresponding input data (x) with n elements into a specific memory address to be accessed for reading or writing;
a weight decoder, directly coupled to the non-volatile memory device with a plurality of high bandwidth data bus, configured to fetch weights from the non-volatile memory and arrange corresponding weight data (w) with n elements into a specific memory address to be accessed for reading or writing;
a product engine circuit comprising a group of dot product engines for taking the input data (x) and the weight data (w), both with the n elements, and returning weighted sum (y);
a quantization logic arranged between the product engine and the input circuit, configured to quantize the weighted sum (y) into a smaller set of discrete values; and
a control logic circuit configured to selectively enable or disable data elements of each data input data (x) a specific number of times in producing the weighted sum (y).

2. The computing device of claim 1, the input circuit comprises an input buffer that temporarily stores data from the host device while the data is being moved from the host device to the input decoder.

3. The computing device of claim 2, wherein the input circuit further comprises a ping-pong buffer having two buffers of equal or different size, which alternately write back and output data for predefined cycles in a way that while the input decoder reads from a first buffer, the quantization logic circuit writes to a second buffer, and once the input decoder has finished reading from the first buffer, the first buffer is switched back to the write back buffer from the quantization logic circuit and the second buffer is switched to transfer the stored data to the input decoder.

4. The computing device of claim 3, wherein the input circuit further comprises a multiplexer having multiple input lines connected to both the input buffer and ping-pong buffer and a single outline connected to the input decoder, said output line carries selected input from either the input buffer or the ping-pong buffer.

5. The computing device of claim 1, wherein the input decoder is configured for decoding the data from the input circuit into a suitable format to be processed at the dot product engine circuit and for storing the input data.

6. The computing device of claim 5, wherein the input decoder comprises a plurality of buffer cells for storing multiple elements of the input data (x), said buffer cells being organized in row and column locations.

7. The computing device of claim 1, wherein the weight decoder is configured with multiple memory blocks in parallel to retrieve different portions of the weights stored in the non-volatile memory device simultaneously.

8. The computing device of claim 1, wherein the control logic circuit is configured to repeat a process of allocating memory address for multiple elements of the input data (x) in a row-majoring order by placing an offset at a base address of each row buffer memory in the input decoder.

9. The computing device of claim 8, wherein the control logic circuit is configured to repeat a process of allocating memory address for multiple elements of the input data (x) in column-majoring order by placing an offset at a base address of each row buffer memory in the input decoder.

10. The computing device of claim 1, wherein the control logic circuit is configured to allocate a memory address associated with the non-volatile memory bank that contains a group of weights such that the address space of the bank indicates the address space of the group of weights.

11. The computing device of claim 10, wherein the control logic circuit is configured to generate and transmit enabling signals to activate a plurality of dot product engines for producing dot products as directed.

12. The computing device of claim 11, wherein the control logic circuit is configured to generate and transmit mask control signals to the dot product engines to selectively activate or deactivate elements of the decoded input data x in producing the dot product.

13. The computing device of claim 11, wherein the control logic circuit is configured to determine an iteration number, which is how many times the decoded input data x and decoded weight data w are calculated for a long chain calculation.

14. The computing device of claim 11, wherein the control logic circuit is configured to transmit a number of elements signal specifying the number of the decoded input data and the decoded weight data elements for a single calculation in each DPE.

15. The computing device of claim 1 further comprises an interconnect circuit to which all the input decoder, weight decoder, and control logic circuit are connected in parallel, and a plurality of dot product engines are connected in parallel to the interconnect circuit.

16. The computing device of claim 1, wherein the interconnect circuit is configured to direct individual data from the input decoder, weight decoder, and control logic circuit to inputs to each dot product engine in a synchronized manner.

17. The computing device of claim 1, wherein the dot product engines comprise (i) a plurality of data selectors arranged in parallel for selectively inputting individual elements of the decoded input data x according to the mask control signals received from the control logic circuit, (ii) a plurality of multipliers arranged in parallel to simultaneously multiply the selected elements of the decoded input data x and corresponding multiple elements of decoded weight data w, and (iii) an accumulator for storing multiple additions of output data from the plurality of multipliers.

18. The computing device of claim 1, wherein the quantization logic is connected to a bias buffer, which is arranged between the data bus and the quantization logic, stores a constant value to be added to an intermediate output from the quantization logic for offsetting the intermediate output in a specific direction.

19. The computing device of claim 18, wherein the quantization logic circuit is connected to a scale buffer, which is arranged between the data bus and the quantization logic, stores a constant scale value to be multiplied to a sum of the intermediate output and the bias value for bringing the summed output within a specific range.

20. A method applied into a computing device coupled between a non-volatile memory device and a host device, said method repeats a step comprising:
obtaining and storing inputs from the host device or the computing device;
converting weights from the non-volatile memory into a suitable format to output corresponding dot products;
summing the dot products and quantizing the summed dot product (y) into a value (q) with a targeted format; and
updating inputs with the quantized value (q).
